(19) United States
(12) Patent Application Publication
(10) Pub. No.: US 2014/0136408 A1
(43) Pub. Date: May 15, 2014

(54) KNOW YOUR CUSTOMER (KYC)

(71) Applicant: GOOGLE INC., Mountain View, CA (US)

(72) Inventors: Mark William Andrews, San Francisco, CA (US); Filip Verley, Mountain View, CA (US); Rajan Aswani, Mountain View, CA (US)

(73) Assignee: GOOGLE INC., Mountain View, CA (US)

(21) Appl. No.: 14/081,061

(22) Filed: Nov. 15, 2013

Related U.S. Application Data
(60) Provisional application No. 61/727,099, filed on Nov. 15, 2012.

(51) Int. Cl. G06Q 40/00

(52) U.S. Cl. CPC G06Q 40/02
USPC 705/42

(57) ABSTRACT

Receiving a first set of customer identification and verification data. The first set of data is a proper subset of the data required for access to all the features of a computer-implemented account. Providing to the customer access to a first set of one or more features corresponding to the first set of data. Receiving a customer request for access to an additional feature of the account outside the first set of one or more features. Requesting a second set of customer identification and verification data, wherein the second set of data corresponds to the certain data required for access to the additional feature. Receiving the requested second set of data. Providing to the customer access to the additional feature.

### CROSS REFERENCE TO RELATED APPLICATIONS

This application claims the benefit of U.S. Provisional Patent Application No. 61/727,099, filed Nov. 15, 2012, entitled “Know Your Customer (KYC);” the complete disclosure of which is hereby fully incorporated herein by reference.

### FIELD OF THE TECHNOLOGY

The disclosed technology relates to identity verification in account management. Example embodiments relate to KYC for online financial accounts.

### BACKGROUND

Know Your Customer (KYC) typically refers to: the activities of customer-related due diligence that financial institutions and other regulated companies perform to identify their clients and ascertain relevant information pertinent to doing financial business with them, and to the bank regulation which governs those activities. In the USA, KYC is typically a policy and process implemented to conform to a customer identification program (CIP) mandated under the Bank Secrecy Act and USA PATRIOT Act. While KYC is described herein primarily in a statutory and regulatory framework to illustrate aspects of the present technology, embodiments of the technology can be applied outside the statutory and regulatory framework.

KYC controls typically may include: collection and analysis of basic identity information (Customer Identification Program), name matching against lists of known parties, determination of the customer's risk in terms of propensity to commit money laundering or identity theft; creation of an expectation of a customer's transactional behavior; and monitoring of a customer's transactions against their expected behavior and recorded profile as well as that of the customer's peers.

### BRIEF DESCRIPTION OF THE DRAWINGS

FIG. 1 is a diagram depicting a communications and processing architecture for courier scheduling of the present technology, in accordance with certain example embodiments.

FIG. 2 is a diagram depicting example methods for conducting KYC in accordance with certain example embodiments of the present technology.

FIG. 3 is a diagram depicting an example user interface in accordance with certain example embodiments of the present technology.

FIG. 4 is a diagram depicting example methods for conducting KYC in accordance with certain example embodiments of the present technology.

FIG. 5 is a block diagram depicting a computing machine and a module, in accordance with certain example embodiments.

### SUMMARY

The technology described herein includes computer-implemented methods, computer program products, and systems for account management. In embodiments of the technology, a first set of customer identification and verification data can be received. The first set of data is a proper subset of the data required for access to all the features of a computer-implemented account. Such embodiments can provide, to the customer, access to a first set of one or more features corresponding to the first set of data. A customer request for access to an additional feature of the account outside the first set of one or more features can be received. Such embodiments can request a second set of customer identification and verification data. The second set of data can correspond to the certain data required for access to the additional feature. Upon receiving the requested second set of data, the technology can provide the customer access to the additional feature.

In some such embodiments, access to the first set of one or more features corresponding to the first set of data is limited based on a quantifiable characteristic of the computer-implemented account. In those embodiments, the technology prompts the consumer to provide identification and verification data required to access features of the computer-implemented account outside the features corresponding to the first set of data upon the quantifiable characteristic reaching each of at least one predetermined amount.

In some such embodiments, the technology limits access to the proper subset of features corresponding to the first set of data subject to a limit based on a quantifiable characteristic of the computer-implemented account. In those embodiments, the limit comprises a first threshold and a second threshold greater than the first threshold. Upon exceeding the first threshold, access is limited to one transaction not exceeding the second threshold.

Certain embodiments of the technology can receive a first set of customer personal identifying information. Such embodiments can establish an account of the customer, the account providing access to a proper subset of features of the account corresponding to the first set of customer personal identifying information. Supplemental personal identifying information of the customer can be received by such embodiments. A first portion of the received supplemental personal identifying information cam be compared to a first set of criteria for verifying the identity of the customer. Upon an unfavorable first comparison a second portion of the received supplemental personal identifying information can be compared to a second criteria for verifying the identity of the customer. Upon a favorable second comparison such embodiments of the technology can grant the customer access to features of the computer-implemented account outside the first proper subset of features and corresponding to the favorably compared supplemental personal identifying information.

In some such embodiments, access to the proper subset of features corresponding to the first set of customer personal identifying information is limited based on a quantifiable characteristic of the computer-implemented account. In those embodiments, the technology can prompt the customer, upon the quantifiable characteristic reaching each of at least one predetermined amount, to provide identification and verification data required to access features of the computer-implemented account outside the features corresponding to the first set of customer personal identifying information.

In some such embodiments, access to the proper subset of features corresponding to the first set of customer personal identifying information is subject to a limit based on a quantifiable characteristic of the computer-implemented account. In such embodiments, the limit comprises a first threshold, and a second threshold greater than the first threshold. Upon exceeding the first threshold, access is limited to one transaction not exceeding the second threshold.

In some such embodiments, prior to establishing an account of the customer, the technology can determine whether the received first set of customer personal identifying information characterizes an entry in a list of entities prohibited from establishing an account. For customer personal identifying information characterizing an entry in a list of entities prohibited from establishing an account, such embodiments of the technology can deny the account.

These and other aspects, objects, features, and advantages of the example embodiments will become apparent to those having ordinary skill in the art upon consideration of the following detailed description of illustrated example embodiments.

### DETAILED DESCRIPTION

### Overview

Embodiments of the present technology can enable customers to experience a payment system, typically an electronic payment system, without an onerous requirement to enter highly personal information, such as Social Security Number (SSN) up-front. There are challenges associated with requesting SSN. For many consumers entering this information is off-putting and may lead to discontinued use or abandonment of the application requesting the information. To increase the adoption of an electronic payment system, for example, an electronic wallet, embodiments of the present technology can give a customer access to enhanced capabilities without the immediate requirement to enter their SSN. However, should the customer so desire, they will have the option to enter their SSN up-front. Delaying KYC can mitigate the potentially off-putting request to enter SSN for those who would be anxious about entering such information.

Embodiments of the technology can: give the customer access to basic payment system features with no requirement for additional personal information; enable some enhanced payment system features on a limited trial basis; and enable all payment system features with full KYC.

The Financial Crimes Enforcement Network (or FinCEN) is a bureau of the United States Department of the Treasury that collects and analyzes information about financial transactions in order to combat money laundering, terrorist financiers, and other financial crimes. FinCEN prepaid access rules require certain non-bank entities to collect identifying information from people who obtain access to a “prepaid program.” Under the FinCEN rules, the term “prepaid program” does not include a product that has the following characteristics: provides prepaid access to $1,000 or less; no more than $1,000 can be initially or subsequently loaded, used or withdrawn on any given day; funds cannot be transmitted internationally; no person to person (P2P) payment; no reloads from non-depository sources, though Automated Clearing House (ACH) transfers are allowed, and reloads from credit cards are still being examined.

Data collected in the KYC process can be divided into three (3) types: an identification administration account ID, basic personal information, and sensitive personally identifying information (SPII). One example of an identification administration account ID is a Google Accounts and ID Administration (GAIA) ID. Examples of basic personal information include first name, last name, date of birth (DOB), address, and phone number. An SSN is an example of SPII.

Typically, proxy card, stored value, and person-to-person electronic payment functions require SPII. In proxy card functionality, an electronic device stores account information (or a pointer thereto) for one or more of a debit card, credit card, loyalty card, and gift card (among others). Where the electronic device is a mobile device, such as a mobile phone or tablet computer, instead of paying with cash, check, or a physical credit card, a consumer may use the account information stored on the mobile device to make payment, for example, using a near field communication (NFC) link between the mobile device and an NFC point-of-sale (POS) device, using a short message service (SMS) link between the payer and payee devices, using direct mobile billing, and using wireless application protocol (WAP) for mobile web payments. Proxy card functionality and stored value functionality typically have the same KYC requirements.

Embodiments of the technology can enable a customer to try an electronic payment system up to a predetermined first limit, for example, up to a cumulative payment value of $500. This value may be accessed by selecting a credit or debit card as a backing card for proxy transactions, or it may be accessed by adding value to a stored value account.

Turning now to the drawings, in which like numerals represent like (but not necessarily identical) elements throughout the figures, example embodiments of the present technology are described in detail.

### Example System Architectures

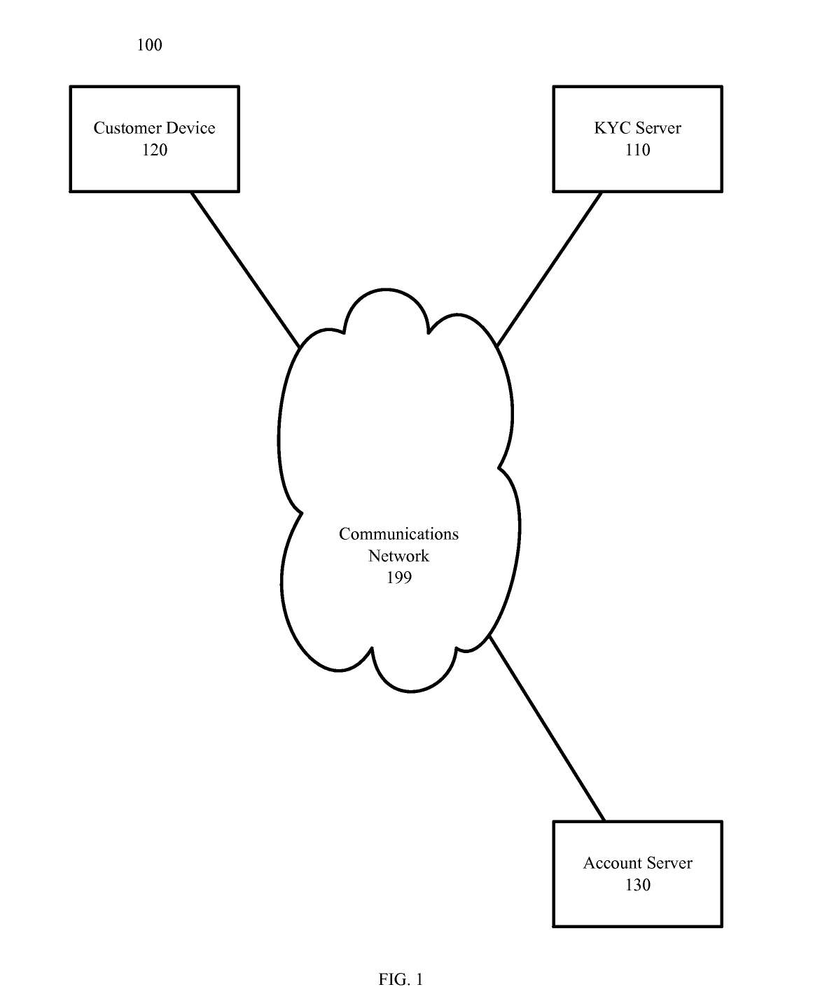

Referring to FIG. 1, an example architecture 100 for performing KYC in embodiments of the present technology is illustrated. While each server, system, and device shown in the architecture is represented by one instance of the server, system, or device, multiple instances of each can be used. Further, while certain aspects of operation of the present technology are presented in examples related to FIG. 1, additional features of the present technology are disclosed elsewhere herein.

As depicted in FIG. 1, the architecture 100 includes network devices 110, 120, and 130; each of which may be configured to communicate with one another via communications network 199. In some embodiments, a customer associated with a device must install an application and/or make a feature selection to obtain the benefits of the technology described herein.

Network 199 includes one or more wired or wireless telecommunications means by which network devices may exchange data. For example, the network 99 may include one or more of a local area network (LAN), a wide area network (WAN), an intranet, an Internet, a storage area network (SAN), a personal area network (PAN), a metropolitan area network (MAN), a wireless local area network (WLAN), a virtual private network (VPN), a cellular or other mobile communication network, a BLUETOOTH® wireless technology connection, a near field communication (NFC) connection, any combination thereof, and any other appropriate architecture or system that facilitates the communication of signals, data, and/or messages. Throughout the discussion of example embodiments, it should be understood that the terms “data” and “information” are used interchangeably herein to refer to text, images, audio, video, or any other form of information that can exist in a computer-based environment.

Each network device can include a communication module capable of transmitting and receiving data over the network 199. For example, each network device can include a server, a desktop computer, a laptop computer, a tablet computer, a television with one or more processors embedded therein and/or coupled thereto, a smart phone, a handheld computer, a personal digital assistant (PDA), or any other wired or wireless processor-driven device. In the example embodiment depicted in FIG. 1, a KYC service operator may operate network device 110. A customer (or potential customer) may operate network device 120. An account operator, such as a bank, may operate device 130.

The network connections illustrated are example and other means of establishing a communications link between the computers and devices can be used. Moreover, those having ordinary skill in the art having the benefit of the present disclosure will appreciate that the network devices illustrated in FIG. 1 may have any of several other suitable computer system configurations. For example, customer device 120 may be embodied as a mobile phone or handheld computer may not include all the components described above. In some embodiments, customer device 120 is a public device, such as an automatic teller machine (ATM) terminal. While the KYC server 110 and the account server 132 are depicted as separate servers, each can be an instance of a process executing on one or more computing devices.

### Example Methods

The example methods illustrated in the following figures are described hereinafter with respect to the components of the example operating environment and example architecture described elsewhere herein. The example methods may also be performed with other systems and in other environments.

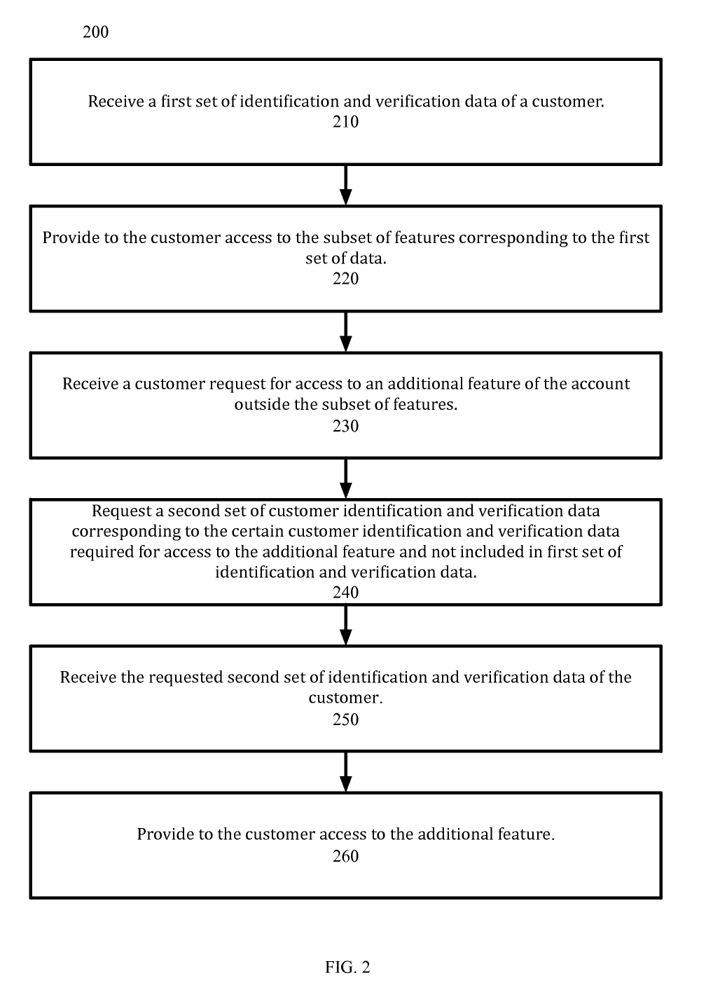

Referring to FIG. 2, and continuing to refer to FIG. 1 for context, example methods 200 of performing KYC are illustrated. In such methods, a first set of identification data and verification data can be received from a customer—Block 210. The first set of data can be a proper subset of the identification and verification data required for access to all the features of a computer-implemented financial account. Each feature of the account requires certain customer identification and verification data as a condition of access to the feature.

For example a customer may use device 120 to access an account server 130 to establish an account subject to a KYC requirement, e.g., a payment account. The account server can initiate a KYC server 110 to initiate KYC procedures with the customer through the customer device 120—requesting only such information as is required to provide basic account functions less than the full account functions. As a continuing example, the technology can receive name (“John Smith”), address (“123 Main St.”), and phone number (“555.123.4567”) from customer John Smith via customer device 120 in order to establish a prepaid debit card account with a balance limit not to exceed $500, no P2P payment capability, and no overdraft protection. For the continuing example, identification and verification data required for access to features of the prepaid debit card account is illustrated in TABLE 1.

TABLE 1

| | ACCOUNT FEATURES | | | | | | | |
|---|---|---|---|---|---|---|---|---|
| | Balance Limit | | | # Trans. | | | | |
| DATA | | >500; | | per mo. | | Cash | P2P | Overdraft |
| REQUIRED | ≦$500 | ≦$1000 | >$1000 | ≦10 | >10 | Advance | Payments | Protection |
| Name | X | X | X | X | X | X | X | X |
| Address | X | X | X | X | X | X | X | X |
| Phone No. | X | X | X | X | X | X | X | X |
| D.O.B. | | X | X | | X | X | X | |
| SSN/TIN | | | X | | X | | X | |
| Backup | | | | | | | | X |
| Acct. No. | | | | | | | | |

Upon satisfactorily completion of initial KYC functions, embodiments of the technology can grant a customer access to the subset of account features corresponding to the first set of data provided by the account server 130 via the customer device 120—Block 220. Embodiments of the technology can cap the number of accounts that can be opened in this fashion, for example, at one. In certain embodiments, the customer can then spend with any frequency they desire, as long as their cumulative spending per account does not exceed the limit amount. In some embodiments, there is no limitation on the number of transactions.

In the continuing example, the data set {<name>, <address>, <phone number>} corresponds to a prepaid payment card account with no cash advance access, a $500 limit, and ≦10 transactions per month. Upon confirmation by the KYC server 110 via public databases that the a person named “John Smith” resides at 123 Main St. and is associated with phone number 555.123.4567, a prepaid payment card account is established in the name of John Smith with these characteristics—typically after payment of a deposit amount as described elsewhere herein.

Embodiments of the technology can receive a request for access to additional features of the account outside the first subset of features—Block 230. In the continuing example, John Smith requests cash advance access on the established account by attempting a cash advance transaction at an automated teller machine (ATM) using a card of account.

Embodiments of the technology can request a second set of customer identification and verification data that is 1) required for access to the additional feature, and 2) not included in the first set of identification and verification data—Block 240. For example, upon the customer requesting functions of the account server 130 beyond those authorized by the initial KYC procedure, the KYC server can conduct KYC to the requirements of the additional functions, e.g., by interacting with the customer through the customer device 120. In the continuing example, after John Smith requests cash advance access on the established account by attempting a cash advance transaction at an automated teller machine (ATM), the KYC server 130 requests the customer's date of birth (DOB) via the customer device 110.

Embodiments of the technology can receive the requested second set of identification and verification data of the customer—Block 250. In the continuing example, Oct. 12, 1980 is received a John Smith's DOB. After completing the second round of KYC, embodiments of the technology allow the customer access to the additional features corresponding to the additional identification and verification data—Block 260. Notice that, for the continuing example per TABLE 1, adding DOB not only allows ATM cash withdrawals, but also allows the account to have balance up to $999.

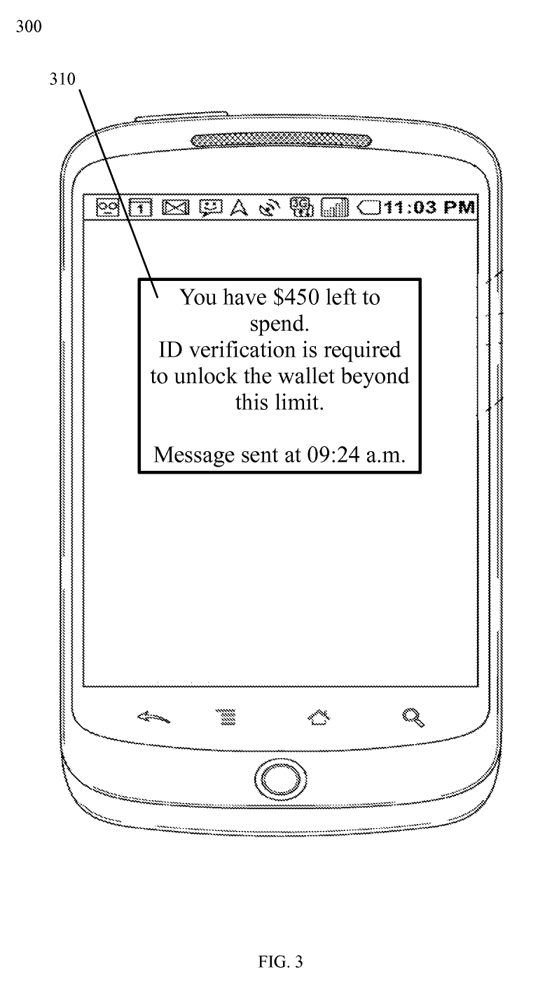

Embodiments of the technology can remind a customer that they need to complete the identification verification process as the value of payments crosses various amounts. For example, in an account characterized by a $500 limit before SPII is collected to complete KYC, the following can be displayed: upon exceeding $100 of payments—‘You have <$500—current cumulative spend> left to spend,’ ‘ID Verification is required to unlock payment system’; upon exceeding $250 of payments—‘You have <$500—current cumulative spend> left to spend,’ ‘ID Verification is required to unlock Payment system’; upon exceeding $350 of payments—‘Completing the ID verification process is advised, you are approaching the limit, you have <$500—current cumulative spend> of spending power remaining’; upon exceeding $400 of payments—‘Please complete the ID verification process, you have <$500—current cumulative spend> of spending power remaining’; for payments initiated between $400-$500 of payments—‘Warning, you have almost reached the spending limit, you must complete the ID verification process to continue using Payment system’. FIG. 3 illustrates an example customer interface 300 providing a reminder 310 that the account has $450 left to spend before the customer must complete KYC, for example, by providing SPII.

In some embodiments, when an account approaches the spending limit, embodiments of the technology allow one transaction exceeding the first limit, as long as the cumulative ceiling does not exceed a second limit, for example a second limit of $600 where the first limit is $500. For instance, if the account has a cumulative spend of $490, and a purchase for $60 is initiated, the purchase will be allowed. If the account has a cumulative spend of $490, and a purchase for $120 is requested, the purchase will not be allowed. While the preceding example is presented in terms of a single account, the principle of a first limit and second limit can be applied cumulative and individually across account owned by a common customer.

In some embodiments, accounts are limited to a maximum cumulative top up, for example a maximum cumulative top up of $250. Top ups can be via ACH, credit or debit card. If the customer exceeds stored value top ups of a third limit, for example $250, embodiments of the technology can advise ‘ID verification is required to use the payment system further.’ Typically, since a customer may opt to adding a backing credit or debit card, rather than using the stored value card initially, this third limit is sensible. The stored value solution can be used as the backing source for proxy transactions.

Embodiments of the technology can track cumulative spend of proxy transactions prior to ID Verification. Cumulative spend can be based on authorized and settled transactions in aggregate. Once a final limiting transaction has been conducted, embodiments of the technology can deselect the payment functionality, for example, deselect the applet on a mobile phone, and the technology can decline future transactions until the KYC process is satisfactorily completed. At anytime throughout the trial process, the embodiments of the technology can offer the customer the option to complete the ID verification process if they desire.

In some embodiments of the technology, stored value top ups can be limited, for example to one half the aggregate spending limit, prior to ID Verification. Note the aggregate spending limit still applies. After the customer hits this $250 barrier, they are required to complete the ID Verification process. The service provider will process all cumulative balance updates and will provide appropriate messaging to the customer. Where the customer exceeds the maximum cumulative spending limit, the proxy credential on the customer's device can be disabled.

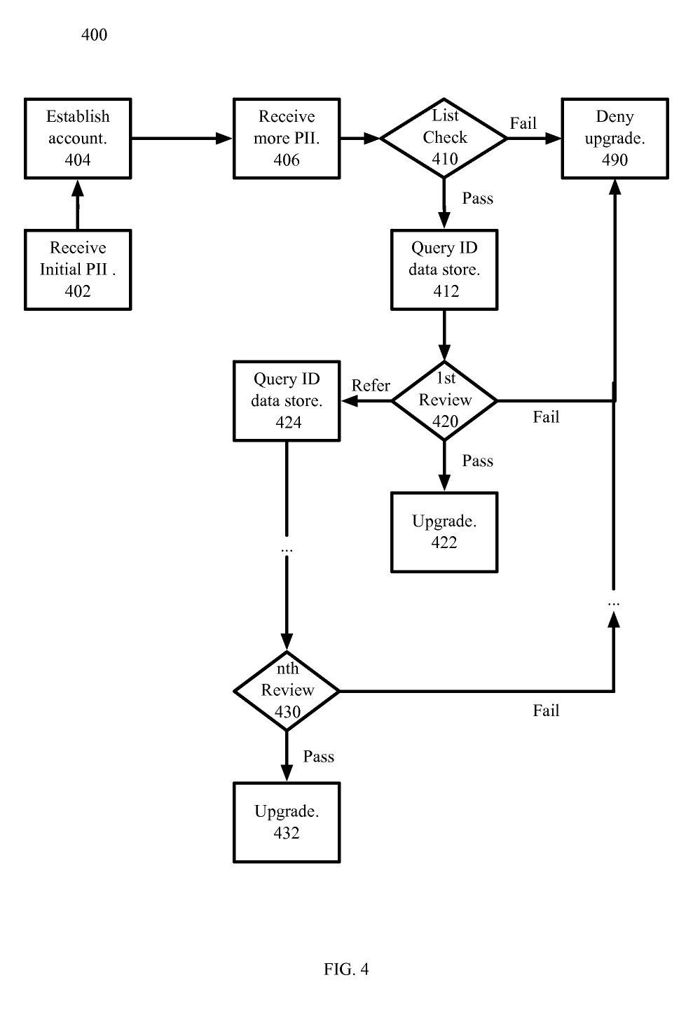

FIG. 4 presents an example process flow 400 for KYC in accordance with example embodiments of the present technology. In such embodiments, the technology implements a multi-tiered review process. Though three (3) tiers (after an initial exclusion list check) are shown in the example of FIG. 4, in other embodiments various numbers of tiers can be employed. The number of tiers employed can depend on the number of alternate means for successfully completing KYC.

In such embodiments, the technology can receive PII data from a customer—Block 402. For example, a customer's name, address, and phone number can received at a KYC server 110. An account with access to set of functions corresponding to the PII received can be established—Block 404. For example, the card that provides access to the financial account can have limits below those that implicate FinCEN CIP requirements.

At some later time, the technology can receive additional PII, such as DOB and SSN—Block 406. The customer can be prompted for the additional PII, for example, in such fashion as described elsewhere herein when crossing spending or other account thresholds. In some embodiments, the customer can initiate submission of additional PII without prompting from the technology. The cumulative PII can be used to check the customer's identity against various lists, such as the lists maintained under section 314(a) of the USA PATRIOT Act, and the Specially Designated Nationals (SDN) list maintained by the Office of Foreign Access Control (OFAC) of the U.S. Dept. of the Treasury—Block 410. If the list check indicates that the customer should not be granted additional features, for example, features that implicate CIP requirements, then the technology will deny the additional features—Block 490. Note that passing such initial checks does not amount to successfully completing KYC, but serves as a threshold requirement for access-controlled account characteristics.

After meeting such threshold requirements, the cumulative PII can used to query an identity verification data store to obtain data relevant to a first test for sufficiently performing KYC—Block 412. For example, the technology can query its own identity verification data store, or the data store of an independent vendor, or both.

Using the retrieved data, a first review can be performed to determine if the customer's identity has been sufficiently verified to upgrade the account—Block 420. There are three (3) possible outcomes from the review of Block 420: pass, fail, and refer. If the review of the data returned from query of Block 412 results in failure, then the technology will deny the upgrade—Block 490. If the review of the data returned from the query of Block 412 verifies the identity of the customer, then the technology will allow the customer access to the functions corresponding to the cumulative PII provided (as illustrated in TABLE 2 herein)—Block 422.

If the outcome of the first review is neither sufficient to deny or approve access to the relevant account characteristics, embodiments of the technology can perform a second query directed to an independent, auxiliary, or supplemental set of criteria for performing KYC—Block 424. For example, if some subset of the cumulative PII reveals multiple matches and is insufficient to resolve the identity of the customer, then the process can be referred to the next stage, queries another data store in an attempt to resolve the ambiguity.

Using the data retrieved in Block 424, a subsequent review can be performed to determine if the customer's identity has been sufficiently verified to upgrade the account—Block 430. If the subsequent review if the final review, there are two (2) possible outcomes from the review of Block 430: pass, and fail. If the review of the data returned from query of Block 422 results in failure, then the technology will deny the upgrade—Block 490. If the review of the data returned from the query of Block 424 verifies the identity of the customer, then the technology will allow the customer access to the functions corresponding to the cumulative PII provided (as illustrated in TABLE 2 herein)—Block 432.

Embodiments of the present technology can increase the likelihood of successful ID verification and remove the potentially off-putting request to enter Social Security Number for those who would be anxious about entering such information. Rather, such embodiments can allow such customers limited access to an electronic payment product first by allowing them to use it, and later require that they provide their SSN. It is less of a leap of faith to enter SSN once the customer knows and hopefully likes the product.

Such an approach allows prompting the customer for personal information at a later stage. The intention is to get the customer to the product first and then they would be more comfortable providing details like their Social Security Number after such trial/introductory use. This approach can lower barriers to entry for the consumer, so that the consumer can use the product straight away rather than being subjected to input SSN, etc. when they may not yet trust the product.

Consider, as further explanation, that FinCEN regulations require that certain institutions involved in financial services, such as a company offering electronic payments, validate customers under certain conditions. Embodiments of the present technology the customers access to the financial services, but can restrict the access up to the required limits. Such embodiments do not change the basic product that may be experienced by a non-validated customer, but allow such a customer to “get a taste” and use the product. Once use of the product by a specific customer meets the requirement for validation, there is a regulatory requirement to complete KYC. Embodiments of the present technology can interrupt the product flow and serve up KYC pages to collect and screen the data.

In some embodiments, the technology can serve KYC pages prior to when the customer is about to exceed a predetermined limit. A transaction is tried, and before it is authorized, the technology can send the customer a message, for example, in-app or via email, that KYC must be completed successfully before the transaction can be completed.

Rather than terminating a transaction for which the requisite level of KYC has yet to be successfully completed, or denying access from beginning to a transaction for which the requisite level of KYC has yet to be successfully complete, embodiments of the present technology can bypass this bad experience by providing the customer an a opportunity to complete the requisite level of KYC, so in essence the customer may continue using the product while having minimal interruption. Keeping the customer in the ongoing transaction while allowing the requisite KYC to be performed is an advantage of such embodiments.

Some embodiments of the technology provide a customer the ability to use a product before completing KYC, and can allow the customer to use the product up to a certain limit. Once the customer gets close or exceeds that limit, the transaction flow is interrupted and appropriate KYC pages are served. Such embodiments can allow the customer to continue using the product while KYC is completed.

Existing approaches typically do not interrupt a specific action, but just stop the usage of the product, and the customer will have to go offline or through some other process to complete the KYC process. Once that happens, there may be a higher risk of losing customers, and this is especially true for a product that is an impulsive download.

Embodiments of the technology attempt to reduce the interruption to the customer by allowing them to complete KYC then continue using the product. Typically in existing approaches, most products stop working and customers have to complete the process offline; which could take minutes, hours, and days. That may reduce a customer's interest in the product as a whole and may create a bad experience.

Consider embodiments of the present technology as part of providing KYC on an electronics payments platform (including, for example, proxy cards, stored value, P2P payments, prepaid accounts) in a common, unified way, regardless of properties or products available through the platform. In some embodiments, the payments platform can provide the common input, verification, and storage of KYC; but each product or properties, as required, will trigger collection & verification of KYC on an incremental/as needed basis.

KYC may include collecting pertinent data from a customer (“identify”), and verifying the customer's identity (“verify”) the level of information to collect, and when and how to verify can vary by product. Generally, KYC rules are more stringent if the product is a payment related product such as p2p or stored value vs. a non-payment product.

Some embodiments of the technology provide a uniform and unified KYC customer experience across a plurality of products and services win a payment platform. Some embodiments of the technology implement centralized storage, for example, non-redundant mastering and a commonly accessible application programming interface (API), for KYC information. Storing pertinent customer data and its verification status in a centralized fashion can allow each product in a payment platform to leverage from that service. This approach can avoid redundancies by asking the customer pertinent information only once and minimizing the verification process. Pertinent customer data can include: i) name, address, email address, phone no, date of birth, taxpayer identification number (TIN), type of customer, etc.

One implication of this is common storage can be that if a KYC service/UI has been used to collect TIN, a subsequent request for TIN in the withholding tax form can get the TIN from the same place and not need to re-ask. Similarly, if a tax form already has TIN, there may be no need to request the customer's TIN again for KYC purposes.

Additional information about the customer gathered from third parties can also be centralized as noted above in embodiments of the technology. For example, the information gathered by a credit team about the customer can be logged in as form fields as opposed to being listed as notes or attachments in the customer profile. Certain fields (e.g., name and date of birth) also can be collected and stored outside of a payment platform (e.g. part of an administrative id).

In some embodiments of the present technology, KYC can be performed as follows. Each product or actions within a product can carry a mapping of the minimum level of customer information required for KYC. This can be referred to as the KYC service related to identity. The KYC service (in some embodiments an API) can collect the required information before a customer is granted access to that action or product.

Some embodiments of the present technology can implement a point system for each of the verification process that product requires. The KYC service can map out the number of points needed to gain access to a product or an action within a product. For example, an event such as receiving a large p2p transfer can trigger the KYC service to cross reference that service to the number of points needed as well as what customer data is available. If a deficit exists, then the customer can be subject to additional verification steps as required to complete KYC to the point level required by the service.

For example, if a customer wants to receive a p2p transfer, the KYC service can check if a TIN is available for this customer before initiating a request to collect TIN, and before completing the transaction. The customer may have previously provided TIN thru tax requirements where a TIN is required before disbursements are initiated to payees.

Minimal customer data can be collected during the enrollment process and additional customer information can be collected only as needed or legally required.

The KYC service can collect the required data from the customer to perform that action or access that product if such data is not available at the current KYC level of the customer.

Embodiments of the present technology can be product-agnostic and service-agnostic, presenting a common UI and KYC data collection flow across modalities. Such a UI can be used to collect required customer data to meet KYC requirements. Such data can include TIN or partial TIN, DOB, full address, etc.

Some embodiments of the present technology can conduct verification for payments-related products through third party vendors. In addition, embodiments also can support the use of Out Of Wallet (OOW) questions and answers for verification.

Some embodiments can conduct verification Using a customer's bank account (e.g., thru challenge deposits, through third party verification service), credit checks; address validation (e.g., using a postcard with PIN validation process, using a 3^{rd} party vendor); and SSN/TIN validation

### Other Example Embodiments

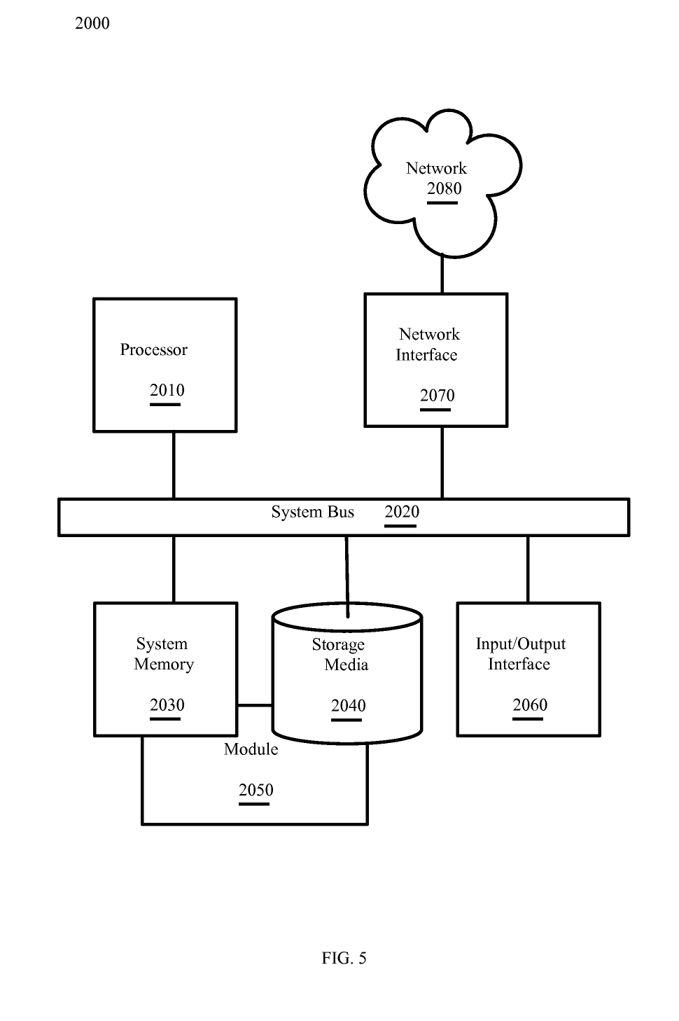

FIG. 5 depicts a computing machine 2000 and a module 2050 in accordance with certain example embodiments. The computing machine 2000 may correspond to any of the various computers, servers, mobile devices, embedded systems, or computing systems presented herein. The module 2050 may comprise one or more hardware or software elements configured to facilitate the computing machine 2000 in performing the various methods and processing functions presented herein. The computing machine 2000 may include various internal or attached components, for example, a processor 2010, system bus 2020, system memory 2030, storage media 2040, input/output interface 2060, and a network interface 2070 for communicating with a network 2080.

The computing machine 2000 may be implemented as a conventional computer system, an embedded controller, a laptop, a server, a mobile device, a smartphone, a set-top box, a kiosk, a vehicular information system, one more processors associated with a television, a customized machine, any other hardware platform, or any combination or multiplicity thereof. The computing machine 2000 may be a distributed system configured to function using multiple computing machines interconnected via a data network or bus system.

The processor 2010 may be configured to execute code or instructions to perform the operations and functionality described herein, manage request flow and address mappings, and to perform calculations and generate commands. The processor 2010 may be configured to monitor and control the operation of the components in the computing machine 2000. The processor 2010 may be a general purpose processor, a processor core, a multiprocessor, a reconfigurable processor, a microcontroller, a digital signal processor (DSP), an application specific integrated circuit (ASIC), a graphics processing unit (GPU), a field programmable gate array (FPGA), a programmable logic device (PLD), a controller, a state machine, gated logic, discrete hardware components, any other processing unit, or any combination or multiplicity thereof. The processor 2010 may be a single processing unit, multiple processing units, a single processing core, multiple processing cores, special purpose processing cores, co-processors, or any combination thereof. According to certain embodiments, the processor 2010 along with other components of the computing machine 2000 may be a virtualized computing machine executing within one or more other computing machines.

The system memory 2030 may include non-volatile memories, for example, read-only memory (ROM), programmable read-only memory (PROM), erasable programmable read-only memory (EPROM), flash memory, or any other device capable of storing program instructions or data with or without applied power. The system memory 2030 may also include volatile memories, for example, random access memory (RAM), static random access memory (SRAM), dynamic random access memory (DRAM), and synchronous dynamic random access memory (SDRAM). Other types of RAM also may be used to implement the system memory 2030. The system memory 2030 may be implemented using a single memory module or multiple memory modules. While the system memory 2030 is depicted as being part of the computing machine 2000, one skilled in the art will recognize that the system memory 2030 may be separate from the computing machine 2000 without departing from the scope of the subject technology. It should also be appreciated that the system memory 2030 may include, or operate in conjunction with, a non-volatile storage device, for example, the storage media 2040.

The storage media 2040 may include a hard disk, a floppy disk, a compact disc read only memory (CD-ROM), a digital versatile disc (DVD), a Blu-ray disc, a magnetic tape, a flash memory, other non-volatile memory device, a solid sate drive (SSD), any magnetic storage device, any optical storage device, any electrical storage device, any semiconductor storage device, any physical-based storage device, any other data storage device, or any combination or multiplicity thereof. The storage media 2040 may store one or more operating systems, application programs and program modules, for example, module 2050, data, or any other information. The storage media 2040 may be part of, or connected to, the computing machine 2000. The storage media 2040 may also be part of one or more other computing machines that are in communication with the computing machine 2000, for example, servers, database servers, cloud storage, network attached storage, and so forth.

The module 2050 may comprise one or more hardware or software elements configured to facilitate the computing machine 2000 with performing the various methods and processing functions presented herein. The module 2050 may include one or more sequences of instructions stored as software or firmware in association with the system memory 2030, the storage media 2040, or both. The storage media 2040 may therefore represent examples of machine or computer readable media on which instructions or code may be stored for execution by the processor 2010. Machine or computer readable media may generally refer to any medium or media used to provide instructions to the processor 2010. Such machine or computer readable media associated with the module 2050 may comprise a computer software product. It should be appreciated that a computer software product comprising the module 2050 may also be associated with one or more processes or methods for delivering the module 2050 to the computing machine 2000 via the network 2080, any signal-bearing medium, or any other communication or delivery technology. The module 2050 may also comprise hardware circuits or information for configuring hardware circuits, for example, microcode or configuration information for an FPGA or other PLD.

The input/output (I/O) interface 2060 may be configured to couple to one or more external devices, to receive data from the one or more external devices, and to send data to the one or more external devices. Such external devices along with the various internal devices may also be known as peripheral devices. The I/O interface 2060 may include both electrical and physical connections for operably coupling the various peripheral devices to the computing machine 2000 or the processor 2010. The I/O interface 2060 may be configured to communicate data, addresses, and control signals between the peripheral devices, the computing machine 2000, or the processor 2010. The I/O interface 2060 may be configured to implement any standard interface, for example, small computer system interface (SCSI), serial-attached SCSI (SAS), fiber channel, peripheral component interconnect (PCI), PCI express (PCIe), serial bus, parallel bus, advanced technology attached (ATA), serial ATA (SATA), universal serial bus (USB), Thunderbolt, FireWire, various video buses, and the like. The I/O interface 2060 may be configured to implement only one interface or bus technology. Alternatively, the I/O interface 2060 may be configured to implement multiple interfaces or bus technologies. The I/O interface 2060 may be configured as part of, all of, or to operate in conjunction with, the system bus 2020. The I/O interface 2060 may include one or more buffers for buffering transmissions between one or more external devices, internal devices, the computing machine 2000, or the processor 2010.

The I/O interface 2060 may couple the computing machine 2000 to various input devices including mice, touch-screens, scanners, electronic digitizers, sensors, receivers, touchpads, trackballs, cameras, microphones, keyboards, any other pointing devices, or any combinations thereof. The I/O interface 2060 may couple the computing machine 2000 to various output devices including video displays, speakers, printers, projectors, tactile feedback devices, automation control, robotic components, actuators, motors, fans, solenoids, valves, pumps, transmitters, signal emitters, lights, and so forth.

The computing machine 2000 may operate in a networked environment using logical connections through the network interface 2070 to one or more other systems or computing machines across the network 2080. The network 2080 may include wide area networks (WAN), local area networks (LAN), intranets, the Internet, wireless access networks, wired networks, mobile networks, telephone networks, optical networks, or combinations thereof. The network 2080 may be packet switched, circuit switched, of any topology, and may use any communication protocol. Communication links within the network 2080 may involve various digital or an analog communication media, for example, fiber optic cables, free-space optics, waveguides, electrical conductors, wireless links, antennas, radio-frequency communications, and so forth.

The processor 2010 may be connected to the other elements of the computing machine 2000 or the various peripherals discussed herein through the system bus 2020. It should be appreciated that the system bus 2020 may be within the processor 2010, outside the processor 2010, or both. According to some embodiments, any of the processor 2010, the other elements of the computing machine 2000, or the various peripherals discussed herein may be integrated into a single device, for example, a system on chip (SOC), system on package (SOP), or ASIC device.

In situations in which the technology discussed here collects personal information about customers, or may make use of personal information, the customers may be provided with a opportunity to control whether programs or features collect customer information (e.g., information about a customer's social network, social actions or activities, profession, a customer's preferences, or a customer's current location), or to control whether and/or how to receive content from the content server that may be more relevant to the customer. In addition, certain data may be treated in one or more ways before it is stored or used, so that personally identifiable information is removed. For example, a customer's identity may be treated so that no personally identifiable information can be determined for the customer, or a customer's geographic location may be generalized where location information is obtained (for example, to a city, ZIP code, or state level), so that a particular location of a customer cannot be determined. Thus, the customer may have control over how information is collected about the customer and used by a content server.

Embodiments may comprise a computer program that embodies the functions described and illustrated herein, wherein the computer program is implemented in a computer system that comprises instructions stored in a machine-readable medium and a processor that executes the instructions. However, it should be apparent that there could be many different ways of implementing embodiments in computer programming, and the embodiments should not be construed as limited to any one set of computer program instructions. Further, a skilled programmer would be able to write such a computer program to implement an embodiment of the disclosed embodiments based on the appended flow charts and associated description in the application text. Therefore, disclosure of a particular set of program code instructions is not considered necessary for an adequate understanding of how to make and use embodiments. Further, those skilled in the art will appreciate that one or more aspects of embodiments described herein may be performed by hardware, software, or a combination thereof, as may be embodied in one or more computing systems. Moreover, any reference to an act being performed by a computer should not be construed as being performed by a single computer as more than one computer may perform the act.

The example embodiments described herein can be used with computer hardware and software that perform the methods and processing functions described previously. The systems, methods, and procedures described herein can be embodied in a programmable computer, computer-executable software, or digital circuitry. The software can be stored on computer-readable media. For example, computer-readable media can include a floppy disk, RAM, ROM, hard disk, removable media, flash memory, memory stick, optical media, magneto-optical media, CD-ROM, etc. Digital circuitry can include integrated circuits, gate arrays, building block logic, field programmable gate arrays (FPGA), etc.

The example systems, methods, and acts described in the embodiments presented previously are illustrative, and, in alternative embodiments, certain acts can be performed in a different order, in parallel with one another, omitted entirely, and/or combined between different example embodiments, and/or certain additional acts can be performed, without departing from the scope and spirit of various embodiments. Accordingly, such alternative embodiments are included in the technology described herein.

Although specific embodiments have been described above in detail, the description is merely for purposes of illustration. It should be appreciated, therefore, that many aspects described above are not intended as required or essential elements unless explicitly stated otherwise. Modifications of, and equivalent components or acts corresponding to, the disclosed aspects of the example embodiments, in addition to those described above, can be made by a person of ordinary skill in the art, having the benefit of the present disclosure, without departing from the spirit and scope of embodiments defined in the following claims, the scope of which is to be accorded the broadest interpretation so as to encompass such modifications and equivalent structures.

We claim:

1. A computer-implemented method for account management comprising:
receiving, via at least one computing device, a first set of customer identification and verification data, wherein the first set of data is a proper subset of the data required for access to all the features of a computer-implemented account;
providing to the customer, via the at least one computing device, access to a first set of one or more features corresponding to the first set of data;
receiving, via the at least one computing device, a customer request for access to an additional feature of the account outside the first set of one or more features;
requesting, via the at least one computing device, a second set of customer identification and verification data, wherein the second set of data corresponds to the certain data required for access to the additional feature;
receiving, via at least one computing device, the requested second set of data; and
providing to the customer, via the at least one computing device, access to the additional feature.

2. The method of claim 1:
wherein access to the first set of one or more features corresponding to the first set of data is limited based on a quantifiable characteristic of the computer-implemented account; and
the method further comprises, prompting, via the at least one computing device, the consumer to provide identification and verification data required to access features of the computer-implemented account outside the features corresponding to the first set of data upon the quantifiable characteristic reaching each of at least one predetermined amount.

3. The method of claim 1:
further comprising, limiting, via the at least one computing device, access to the proper subset of features corresponding to the first set of data subject to a limit based on a quantifiable characteristic of the computer-implemented account; and
wherein: the limit comprises a first threshold, and a second threshold greater than the first threshold; and upon exceeding the first threshold, access is limited to one transaction not exceeding the second threshold.

4. A computer-implemented method for account management comprising:
receiving, via at least one computing device, a first set of customer personal identifying information;
establishing, via the at least one computing device, an account of the customer, the account providing access to a proper subset of features of the account corresponding to the first set of customer personal identifying information;
receiving, via the at least one computing device, supplemental personal identifying information of the customer;
first comparing, via the at least one computing device, a first portion of the received supplemental personal identifying information to a first set of criteria for verifying the identity of the customer;
upon an unfavorable first comparison, second comparing, via the at least one computing device, a second portion of the received supplemental personal identifying information to a second criteria for verifying the identity of the customer; and
upon a favorable second comparison, granting, via the at least one computing device, the customer access to features of the computer-implemented account outside the first proper subset of features and corresponding to the favorably compared supplemental personal identifying information.

5. The method of claim 4:
wherein access to the proper subset of features corresponding to the first set of customer personal identifying information is limited based on a quantifiable characteristic of the computer-implemented account; and
wherein the method further comprises, prompting the customer, via the at least one computing device, upon the quantifiable characteristic reaching each of at least one predetermined amount, to provide identification and verification data required to access features of the computer-implemented account outside the features corresponding to the first set of customer personal identifying information.

6. The method of claim 4 wherein:
access to the proper subset of features corresponding to the first set of customer personal identifying information is subject to a limit based on a quantifiable characteristic of the computer-implemented account;
the limit comprises a first threshold, and a second threshold greater than the first threshold; and
upon exceeding the first threshold, access is limited to one transaction not exceeding the second threshold.

7. The method of claim 4 further comprising, prior to establishing an account of the customer:
determining, via the at least one computing device, whether the received first set of customer personal identifying information characterizes an entry in a list of entities prohibited from establishing an account;
for customer personal identifying information characterizing an entry in a list of entities prohibited from establishing an account, denying, via the at least one computing device, the account.

8. A computer program product comprising:
a non-transitory computer-readable storage device having computer-executable program instructions embodied thereon that when executed by a computer cause the computer to manage access to an account, the computer-executable program instructions comprising computer-executable program instructions to:
receive a first set of customer identification and verification data, wherein the first set of data is a proper subset of the data required for access to all the features of a computer-implemented account;
provide to the customer access to a first set of one or more features corresponding to the first set of data;
receive a customer request for access to an additional feature of the account outside the first set of one or more features;
request a second set of customer identification and verification data, wherein the second set of data corresponds to the certain data required for access to the additional feature;
receiving the requested second set of data; and
providing to the customer access to the additional feature.

9. The computer program product of claim 8:
wherein access to the first set of one or more features corresponding to the first set of data is limited based on a quantifiable characteristic of the computer-implemented account; and
the computer program product further comprises computer-executable program instructions to prompt the consumer to provide identification and verification data required to access features of the computer-implemented account outside the features corresponding to the first set of data upon the quantifiable characteristic reaching each of at least one predetermined amount.

10. The computer program product of claim 8:
the computer program product further comprises computer-executable program instructions to limit access to the proper subset of features corresponding to the first set of data subject to a limit based on a quantifiable characteristic of the computer-implemented account; and
wherein: the limit comprises a first threshold, and a second threshold greater than the first threshold; and upon exceeding the first threshold, access is limited to one transaction not exceeding the second threshold.

11. A computer program product comprising:
a non-transitory computer-readable storage device having computer-executable program instructions embodied thereon that when executed by a computer cause the computer to manage access to an account, the computer-executable program instructions comprising computer-executable program instructions to:
receive a first set of customer personal identifying information;
establish an account of the customer, the account providing access to a proper subset of features of the account corresponding to the first set of customer personal identifying information;
receive supplemental personal identifying information of the customer;
first compare a first portion of the received supplemental personal identifying information to a first set of criteria for verifying the identity of the customer;
upon an unfavorable first comparison, second compare a second portion of the received supplemental personal identifying information to a second criteria for verifying the identity of the customer; and
upon a favorable second comparison, grant the customer access to features of the computer-implemented account outside the first proper subset of features and corresponding to the favorably compared supplemental personal identifying information.

12. The computer program product of claim 11:
wherein access to the proper subset of features corresponding to the first set of customer personal identifying information is limited based on a quantifiable characteristic of the computer-implemented account; and
the computer-executable program instructions further comprise computer-executable program instructions to prompt the customer upon the quantifiable characteristic reaching each of at least one predetermined amount, to provide identification and verification data required to access features of the computer-implemented account outside the features corresponding to the first set of customer personal identifying information.

13. The computer program product of claim 11 wherein:
access to the proper subset of features corresponding to the first set of customer personal identifying information is subject to a limit based on a quantifiable characteristic of the computer-implemented account;
the limit comprises a first threshold, and a second threshold greater than the first threshold; and
upon exceeding the first threshold, access is limited to one transaction not exceeding the second threshold.

14. The computer program product of claim 11 the computer-executable program instructions further comprise computer-executable program instructions to, prior to establishing an account of the customer:
determine whether the received first set of customer personal identifying information characterizes an entry in a list of entities prohibited from establishing an account; and
for customer personal identifying information characterizing an entry in a list of entities prohibited from establishing an account, deny the account.

15. A system to manage access to an account, the system comprising:
a storage device; and
a processor communicatively coupled to the storage device, wherein the processor executes application code instructions that are stored in the storage device and that cause the system to:
receive a first set of customer identification and verification data, wherein the first set of data is a proper subset of the data required for access to all the features of a computer-implemented account;
provide to the customer access to a first set of one or more features corresponding to the first set of data;
receive a customer request for access to an additional feature of the account outside the first set of one or more features;
request a second set of customer identification and verification data, wherein the second set of data corresponds to the certain data required for access to the additional feature;
receiving the requested second set of data; and
providing to the customer access to the additional feature.

16. The system of claim 15:
wherein access to the first set of one or more features corresponding to the first set of data is limited based on a quantifiable characteristic of the computer-implemented account; and
wherein the processor further executes application code instructions that are stored in the storage device and that cause the system to prompt the consumer to provide identification and verification data required to access features of the computer-implemented account outside the features corresponding to the first set of data upon the quantifiable characteristic reaching each of at least one predetermined amount.

17. The system of claim 15:
wherein the processor further executes application code instructions that are stored in the storage device and that cause the system to limit access to the proper subset of features corresponding to the first set of data subject to a limit based on a quantifiable characteristic of the computer-implemented account; and
wherein: the limit comprises a first threshold, and a second threshold greater than the first threshold; and upon exceeding the first threshold, access is limited to one transaction not exceeding the second threshold.

18. A system to manage access to an account, the system comprising:
a storage device; and
a processor communicatively coupled to the storage device, wherein the processor executes application code instructions that are stored in the storage device and that cause the system to:
receive a first set of customer personal identifying information;
establish an account of the customer, the account providing access to a proper subset of features of the account corresponding to the first set of customer personal identifying information;
receive supplemental personal identifying information of the customer;
first compare a first portion of the received supplemental personal identifying information to a first set of criteria for verifying the identity of the customer;
upon an unfavorable first comparison, second compare a second portion of the received supplemental personal identifying information to a second criteria for verifying the identity of the customer; and
upon a favorable second comparison, grant the customer access to features of the computer-implemented account outside the first proper subset of features and corresponding to the favorably compared supplemental personal identifying information.

19. The system of claim 18:
wherein access to the proper subset of features corresponding to the first set of customer personal identifying information is limited based on a quantifiable characteristic of the computer-implemented account; and
the application code instructions that are stored in the storage device further cause the system prompt the customer upon the quantifiable characteristic reaching each of at least one predetermined amount, to provide identification and verification data required to access features of the computer-implemented account outside the features corresponding to the first set of customer personal identifying information.

20. The system of claim 18 wherein:
access to the proper subset of features corresponding to the first set of customer personal identifying information is subject to a limit based on a quantifiable characteristic of the computer-implemented account;
the limit comprises a first threshold, and a second threshold greater than the first threshold; and
upon exceeding the first threshold, access is limited to one transaction not exceeding the second threshold.
